(19) United States
(12) Patent Application Publication
(10) Pub. No.: US 2016/0171913 A1
(43) Pub. Date: Jun. 16, 2016

(54) SPORTS MEMORABILIA STADIUM SEAT CUP HOLDER BRACKET

(71) Applicant: Daniel Sprinkle, Rushville, IN (US)

(72) Inventor: Daniel Sprinkle, Rushville, IN (US)

(21) Appl. No.: 14/570,272

(22) Filed: Dec. 15, 2014

(51) Int. Cl. G09F 23/00; A47G 23/02

(52) U.S. Cl. CPC G09F 23/00; A47G 23/0216; G09F 2023/0025

(57) ABSTRACT

A method for enhancing sales of retired stadium seat cup holders by utilizing a bracket system, to mount and stabilize a stadium seat cup holder for use outside of the stadium, such as at home or in a commercial setting, with the addition of customization and personalization of the sports memorabilia.

### TECHNICAL FIELD

The present novel technology relates to sports memorabilia and, more specifically, to a bracket used as a method and apparatus for stable display of retired collectible stadium seat cup holders.

### BACKGROUND

Over time, the collection of sports memorabilia has grown from a childhood hobby into a multi-billion dollar industry. Sports memorabilia, such as retired stadium seats and stadium seat cup holders that were once part of famous sports venues or arenas around the country, such as original BUSCH STADIUM® (BUSCH STADIUM is a registered trademark of Anheuser-Busch, Incorporated, a Missouri corporation, located as One Busch Place, St. Louis, Mo. 63118) (colloquially and hereinafter known as Old Busch Stadium), are now highly sought memorabilia by sports enthusiasts and/or collectors who wish to own a piece of sports history.

While in service, stadium seat cup holders are typically mounted directly onto a stadium seat. Thus, when retired stadium seat cup holders are removed from a stadium or sports arena, the cup holders are generally not configured and shaped upright to stand on their own in a manner that would allow the generally cylindrically shaped receptacle to hold a beverage or other item. Retired stadium seat cup holders are thus of minimal functionality, and are generally not considered desirable or useful articles. Therefore, there is a need for an improved method of displaying retired stadium seat cup holders, while also increasing their marketing value through customization and personalization. The present novel technology addresses these needs.

### BRIEF DESCRIPTION OF THE DRAWINGS

FIG. 1 is a front perspective view of a sports memorabilia stadium seat cup holder assembly according to a first embodiment of the present novel technology.

FIG. 2 is a second perspective view of the sports memorabilia stadium seat cup holder assembly of FIG. 1.

FIG. 3 is an exploded view of a sports memorabilia stadium seat cup holder assembly of FIG. 1.

FIG. 4 is a top plan view of the assembly of FIG. 1.

FIG. 5 is a bottom plan view of the assembly of FIG. 1.

FIG. 6 is a rear elevation view of FIG. 1.

FIG. 7 is a side sectional view of the assembly of FIG. 1.

FIG. 8 schematically illustrates a kit embodiment including the embodiment of FIG. 3 as separate pieces.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

The present novel technology relates to a freestanding display assembly 10 for displaying a sports arena or like cup holder 20 previously affixed to stadium seats utilized in sports arenas, such as professional football or baseball stadiums, into a stand-alone memorabilia article that may be displayed and/or utilized as desired. The system 10 for displaying a stadium seat cup holder 20 that is generally inoperable outside of a sports arena includes a stabilizing bracket 25 having a generally circular or oval base portion 25B and a back portion 25A generally conformed to accept a stadium seat cup holder, to yield a free-standing cup holder assembly 10 for use and display outside of a stadium. In addition, the assembly 10 provides a method for enhancing the appearance and utility of cup holders 20 from retired stadium seats, enhancing and adding to the sport memorabilia aspect of the stadium seat cup holder 20. In some embodiments, a personalized decal 30 typically indicating stadium of origin, as well as specific row and seat of origin, and/or self-authentication is connected to the cup holder 20. This operates to provide enhanced utilization of the cup holder 20 in environments outside of a stadium or arena, such as a restaurant, office, or residence.

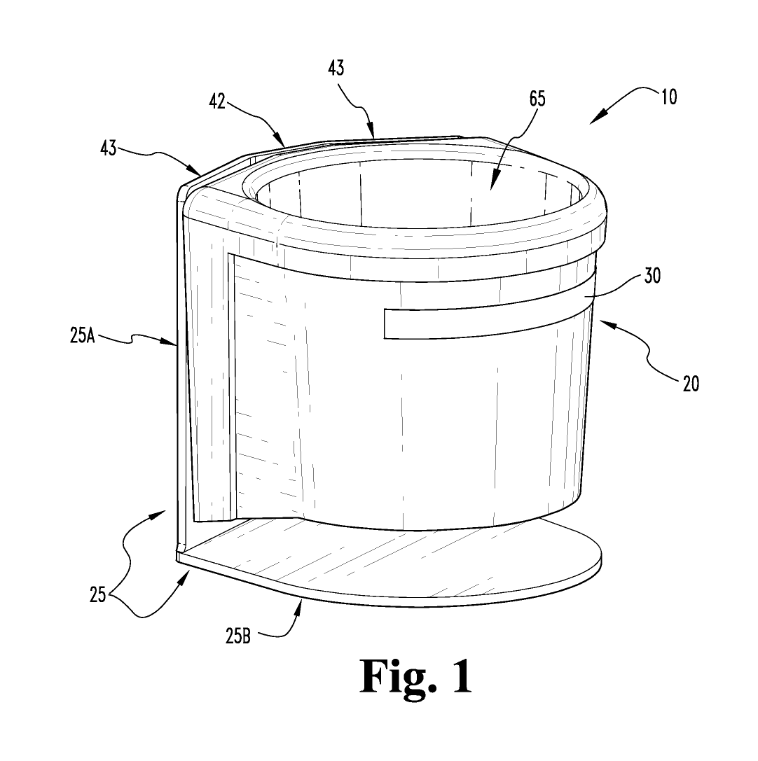

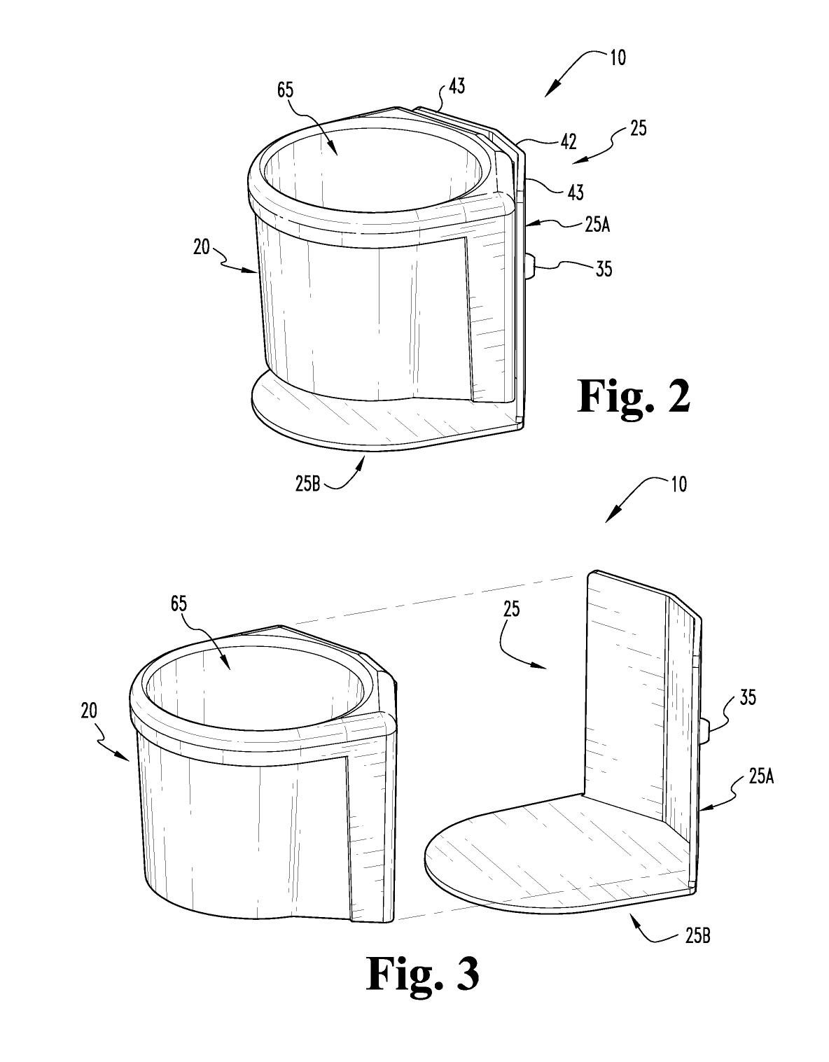

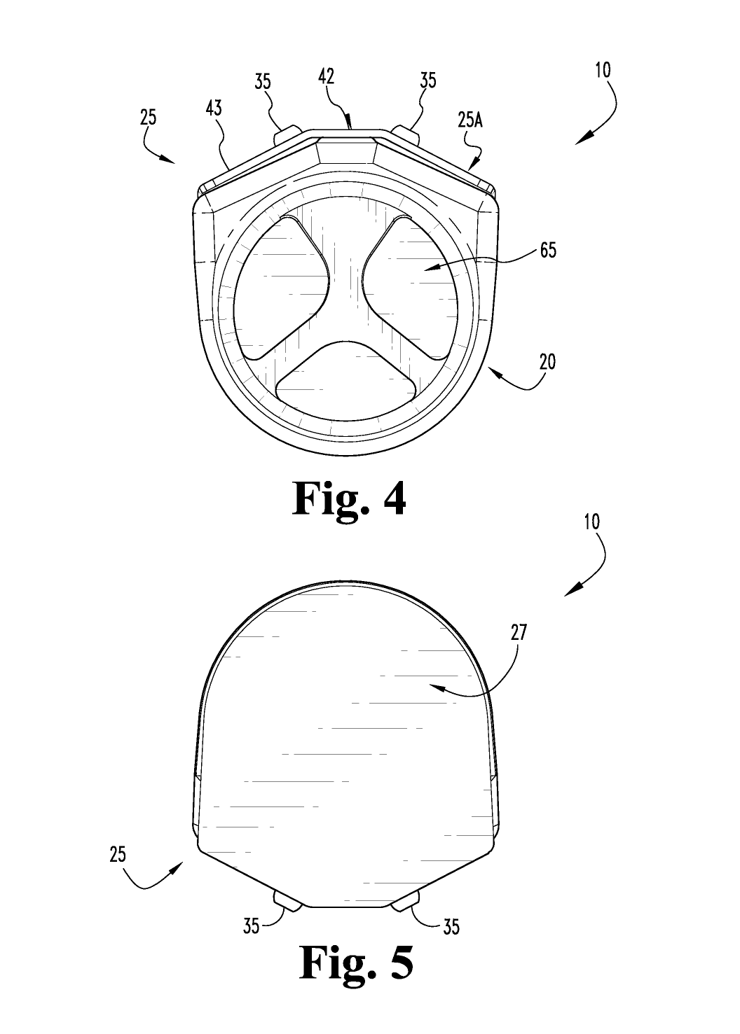

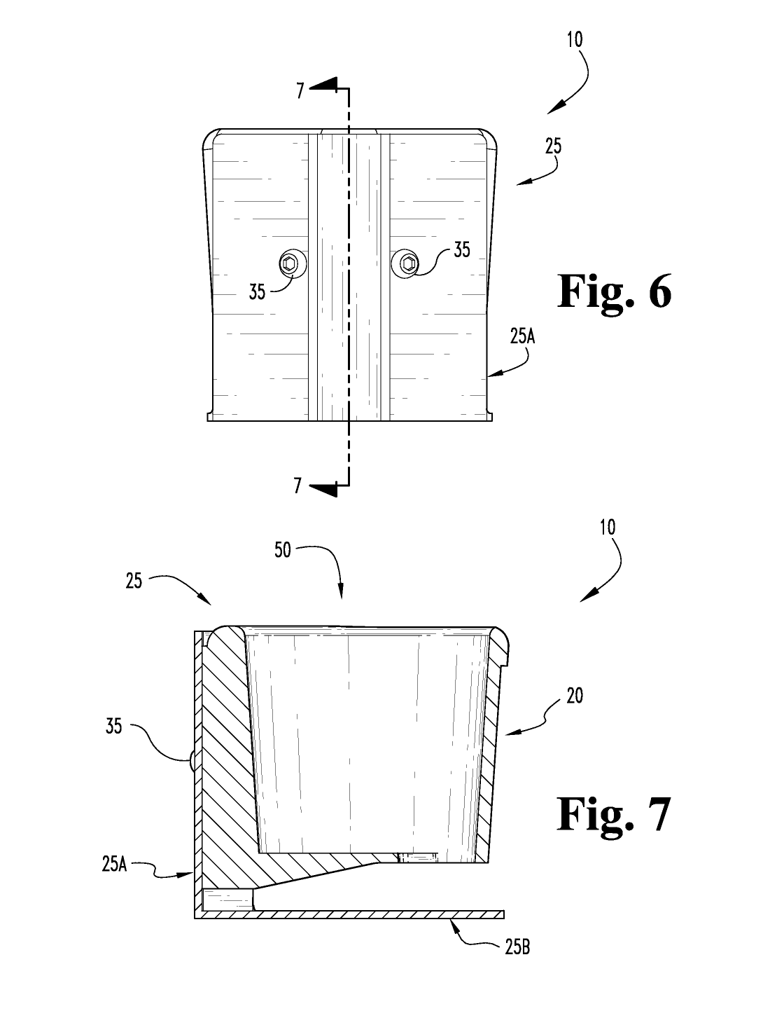

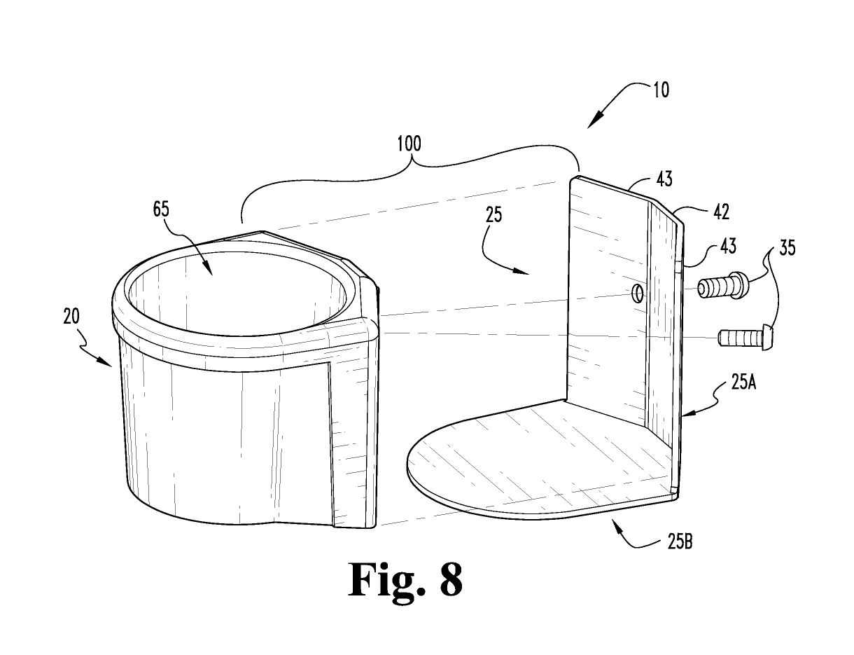

FIGS. 1-7 illustrate a first embodiment of the present novel technology, a sports memorabilia stadium seat cup holder bracket 25 connected to a cup holder 20 once permanently affixed, or removably secured, to a stadium seat. The freestanding display system 10 generally includes a cup holder 20, a generally “L”-shaped bracket 25 consisting of a horizontal base 25B and an orthogonally disposed vertical side member 25A, a plurality of bolts 35 for engaging the bracket 25 with the cup holder 20, and a typically removably secured, or, in the alternate, permanently affixed informational decal 30. The sports memorabilia stadium seat cup holder assembly 10 may consist of a universal bracket system 50 designed to convert the bracket 25 into the appropriate configuration for use with a variety of stadium seat cup holder 20 configurations. Alternatively, the sports memorabilia stadium seat cup holder assembly 10 may be part of a kit 100 comprising of at least one cup holder 20, a mounting bracket 25 sized and shaped to fit the cup holder 20 and generally having an “L”-shape (as illustrated and discussed herein) and at least one fastener 35 sized and adapted for securing the bracket 25 to the cup holder 20, although the fastener 35 may be sized and adapted to secure the cup holder 20 and bracket 25 to an alternate source. Although not inclusive, and in no way restrictive, utilizing the bracket assembly 10 in conjunction with retired stadium seat cup holders 20 enables memorabilia cup holders 20 to be used in a restaurant, to hold condiments and/or menus, in an office or home to hold beverages, and/or office supplies such as pens/pencils and/or paperclips, and/or in conjunction with an insert placed inside the generally cylindrically shaped drink receptacle 65 to enable a baseball or other sports article to be displayed, although any convenient use or setting may be utilized.

Typically, the sports memorabilia stadium seat cup holder bracket 10 which receives and securely affixes to the stadium seat cup holder 20, is typically made out of metal, although any convenient structural material may be selected, and is generally shaped and adapted to span the base of a standard stadium seat cup holder 20 as well as the vertical back portion of a standard stadium seat cup holder 20, although any conveniently sized and/or shaped bracket may be utilized. The bracket's 25 orthogonally disposed vertical side member 25A and horizontal base 25B is generally “L”-shaped with the vertical side member 25A meeting the horizontal base 25B at typically a 90° angle, although the two portions of the bracket 25 may intersect at any angle or point. The horizontal base portion 25B typically includes a pliable foot pad 27, such as a rubber or polymer sheet.

In one embodiment, as illustrated in FIGS. 1-4, and FIG. 6, the bracket's 25 orthogonally disposed vertical side member 25A is shaped and segmented into three portions to generally conform to one common shape of sports memorabilia cup holders 20. The vertical side member 25A consists of a generally flat central portion 42 and two portions 43 extending therefrom at about a 20° angle to the outer edges of the cup holder 20. In an alternate embodiment, the orthogonally disposed vertical side member (not shown) may lie flush against a generally flat backed cup holder 20. In any embodiment, the bracket 25 may be flush with the cup holder 20, or it may include space between the bracket 25 and the cup holder 20 to allow an item to be placed between the two parts.

To enhance the marketing value of the memorabilia stadium seat cup holder 10, the cup holder 20 may include a personalized decal 30 that may be removably attached or permanently affixed, and may memorialize a specific stadium, specific player, specific team, and/or a specific date. Additionally, the decal 30 may be personalized even further to represent the purchaser, such as the purchaser's name, the date of a game they went to, the stadium of their favorite team, and/or any other information selected. Typically, the personalized decal 30 may be made out of decorative medal or a vinyl film comprised of a first and second side, whereon the second side contains an adhesive to attach the vinyl to the cup holder 20, although any convenient material may be selected. In addition, the personalized decal 30 may be in any size or shape, may be located anywhere convenient on the memorabilia stadium seat cup holder 10, and may be engraved, printed, or embossed, although any convenient form of printing may be utilized.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

I claim:

1. An assembly for displaying a memorabilia stadium seat cup holder,
comprising:
a substantially flat base member;
a side member connected to and extending generally vertically from the flat base; and
at least one aperture formed through the side member;
a retired stadium seat cup holder having a mounting interface;
wherein the side member is shaped to accept the stadium seat cup holder mounting interface.

2. The assembly of claim 1 further comprising at least one fastener extending through the at least one aperture and securing the side member to a retired stadium seat cup holder mounting interface.

3. The assembly of claim 1 wherein the orthogonally disposed side member is segmented into a center portion, a first side portion continuous with the center portion and a second, oppositely disposed side portion continuous with the center portion;
wherein the side portions intersect the center portion at an angle of at least 20°.

4. The assembly of claim 1 wherein the orthogonally disposed vertical side member is generally planar.

5. The assembly of claim 1 wherein the aperture is positioned to align with a threaded aperture in the mounting interface.

6. A kit for converting a stadium-mounted cup holder into a free-standing article,
comprising:
at least one sports memorabilia stadium seat cup holder bracket connectible to a retired stadium seat cup holder; and
a plurality of fasteners for securing the at least one bracket to a retired stadium seat cup holder;
wherein the sports memorabilia stadium seat cup holder bracket is shaped to engage a retired stadium seat cup holder.

7. The kit of claim 6 wherein the sports memorabilia stadium seat cup holder contains a customized decal.

8. A kit for securely mounting retired stadium seat cup holders to be utilized on a tabletop surface through the use of a bracket, comprising:
a sports memorabilia stadium seat cup holder;
at least one bracket sized and shaped to connectably receive the sports memorabilia stadium seat cup holder; and
a plurality of apertures formed through the bracket;
a plurality of fasteners;
wherein the sports memorabilia stadium seat cup holder bracket includes a generally flat base member and a generally orthogonally disposed side member connected thereto.

9. The kit of claim 8 wherein the sports memorabilia stadium seat cup holder bracket defines a generally “L”-shaped profile.

10. The kit of claim 8 wherein the sports memorabilia stadium seat cup holder bracket's is shaped and sized to conform to a stadium seat cup holder.

11. The kit of claim 8 and further comprising a decal for authentication of the origin of the stadium seat cup holder.

12. The kit of claim 8 and further comprising a decal featuring a team logo.

13. The kit of claim 8 and further comprising a decal featuring information related to a stadium.

14. A bracket system for converting a retired stadium seat cup holder into a free standing article, comprising:
a retired stadium seat cup holder;
a bracket having a base portion and an orthogonally disposed side member operationally connected to the stadium seat cup holder and the base portion;
a plurality of bolts engaging a sports memorabilia bracket with the stadium seat cup holder;
wherein the side member is shaped to matably engage the mounting interface portion of the cup holder;
wherein base of the bracket is generally circular and sized to a stadium seat cup holder; and
wherein holes located on the side member are lined up to engage the bolts.
